(19) United States
(12) Patent Application Publication
(10) Pub. No.: US 2001/0049636 A1
(43) Pub. Date: Dec. 6, 2001

(54) System and method for wireless purchases of goods and services

(76) Inventors: Amir Hudda, Alexandria, VA (US); Ramzi Barghouthi, Atlanta, GA (US); Molham Aref, Atlanta, GA (US)

Correspondence Address: Roberts Abokhair & Mardula, L.L.C., Suite 1000, 11800 Sunrise Valley Drive, Reston, VA, 20191-5302, US

(21) Appl. No.: 09/835,533

(22) Filed: Apr. 16, 2001

Related U.S. Application Data
(60) Provisional application No. 60/198,088, filed on Apr. 17, 2000.

(51) Int. Cl. G06F 17/60

(52) U.S. Cl. 705/26

(57) ABSTRACT

A consumer wireless shopping device, such as a phone or PDA, communicates with a server for completing purchase transactions. Consumers can store preferences, shopping lists, payment methods and shipping addresses on the server to aid with shopping. The location of the of the device is determined, such as by GPS or RF triangulation, and used by the server to help direct consumers to merchant locations for viewing items to be purchased as well as to inform consumers of special sales or desired items within a specified geographic distance. The system allows for use of various delivery options, including in-store pick-up and Internet fulfillment. The system also allows for use of various price-negotiation methods, including use of auction-bidding, competitor price-matching, and buying clubs, and volume discounting.

### RELATED APPLICATIONS

This application claims the benefit of U.S. Provisional Application Ser. No. 60/198,088, filed Apr. 17, 2000, which is herein incorporated by reference.

### FIELD OF THE INVENTION

This invention relates generally to purchasing of goods and services via a wireless shopping device. More particularly, the present invention is a system and method for using wireless shopping devices to attract a consumer to a store, to purchase goods and services via wireless interaction with the Retailer, without requiring the retail establishment to stock a complete line of inventory for customers.

### BACKGROUND OF THE INVENTION

Purchasing of goods and services in retail establishments or “stores” formerly was a way of life. A customer would go to a store, be able to see the merchandise of interest, select a size and color of the merchandise desired, stand in a line to pay for the goods and services, pay for the goods, and take the goods home.

However, in order for a retail establishment to be successful, it had to store a substantial inventory in order to meet the customer's demands for size, color, and other characteristics. The problem of inventory stocking and management is expanded with every product line carried by a store. In addition, inventory might be present in one store and not be present in another, leading consumers to be discouraged in their shopping experience and/or having to travel to yet another store in order to obtain the goods desired.

With the advent of the Internet, a number of these problems have been made much simpler. Consumers purchasing goods and services on the Internet now view a picture of the goods desired, and purchase the goods. The goods are subsequently delivered by any number of different means to the customer at a subsequent time.

This invention now opens the way for a new group of Internet Retailers (e-tailers) to exist and compete heavily with traditional “Brick and Mortar” Retailers. E-tailers might have only one warehouse filled with merchandise making inventory control simpler by the fact that only one location has all of the goods to be shipped. There is not the problem of, for example, a shirt in one color but the wrong size present at one store and a shirt that is the correct size being available at another store. All goods are located in one place. Therefore fulfillment of a customer's order is greatly simplified

However, Internet shopping, as large an enterprise as it is, is not accepted by a very large number of the consuming population that desires to see and touch the merchandise that they wish to purchase. For this to take place, the consumer must proceed to a retail establishment and use the old paradigm of finding the desired goods, hoping they are in the correct size and color, and purchasing the goods in a conventional fashion. Even with that, new companies are planning to offer services where a consumer will go into the store, see, touch and try on the merchandise, use a wireless device to connect and compare-shop the same merchandise at various e-tailors and order from the most convenient for later delivery. This will further hurt the traditional Brick and Mortar Retailers by becoming mostly a showcase for merchandise that gets purchased over the Internet from other suppliers.

For large and small retailers alike, this might drive these companies out of business. What would therefore be desirable is a system which allows a consumer to proceed to a retail establishment, see the actual goods to be purchased, give the Retailer the opportunity to work out a deal with the consumer to purchase the goods in a more convenient fashion and at a competitive price and have those goods sent to the consumer's home. Such a system would also be used by retailers of any size.

### SUMMARY OF THE INVENTION

It is therefore an objective of the present invention to allow consumers to see and touch the merchandise that consumers wish to purchase, while offering the consumer the convenience of wireless interaction with the merchant in whose store the consumer is located.

It is yet another objective of the present invention to allow consumers to purchase the merchandise with the convenience of wireless interaction with the merchant while the consumer is not actually at the store.

It is a further objective of the present invention to minimize inventory-stocking issues for retailers of all sizes.

It is yet another objective of the present invention to allow wireless purchasing of goods at a retailer with subsequent delivery as desired by a consumer.

It is yet another objective of the present invention to allow consumers to use a wireless shopping device to determine the physical location of the goods desired.

It is yet another objective of the present invention to allow consumers to determine the location where the desired goods are sold and which location is close to the physical location of the consumer.

It is yet another objective of the present invention to allow consumers to purchase a product “on the spot” in the retail establishment via a wireless shopping device. It is a further objective of the present invention to permit consumers to establish a list of products and services that are desired by the consumer (a private or public wish list) and which may be purchased by others for the consumer as in a gift registry.

It is still another objective of the present invention to permit consumers to send gifts to others via wireless interaction with the retailer while in the store or remote from the store. It is yet another objective of the present invention to permit consumers to select, gift wrap, and send personalized cards along with selected gifts.

It is yet another objective of the present invention to allow consumers to pre-register their desires for goods and services and have a server transmit information on the desired goods and services, and where the goods and services can be obtained, to the consumer when the desired goods and services are on sale.

It is a further objective of the present invention to permit in-store bidding using a wireless shopping device for goods and services by consumers.

It is still another objective of the present invention to permit consumers to start and/or to join in-store buyer's groups in order to obtain the best prices for the desired goods and services.

It is yet another objective of the present invention to offer consumers a 1-click shopping service during wireless interaction with the merchant while in-store or remotely. The service allows consumers to pre-define all required data including but not limited to billing information and delivery address for faster processing of the purchase order.

It is yet another objective of the present invention to allow consumers to re-order previously purchased goods either by scanning the already purchased product or looking it up through the service databases.

It is yet another objective of the present invention to allow consumers to inquire about out-of-stock merchandise.

It is yet another objective of the present invention to permit consumers to order goods not present at a store where they are shopping and present in another.

It is yet another objective of the present invention to provides consumer reviews of goods and services, in-store, that a consumer desires to purchase, via a wireless connection to the consumer to assist in the buying decision.

It is a further objective of the present invention to “push” information on sales of goods and services that are desired by a consumer to the consumer while the consumer is in-store at a retail establishment or when the consumer is within a pre-defined distance of the store.

It is still another objective of the present invention to provide consumers with a wireless method for specifying delivery options for goods that are purchased.

It is yet another objective of the present invention to provide a unique purchase code that can be used by the consumer during checkout when the consumer wishes to physically purchase the desired goods and leave the store with those goods.

It is yet another objective of the present invention to tie stores together in a single retailing unit that will honor sales and deals made with a consumer for the purchase of goods.

It is a further objective of the present invention to tie any transaction code into an inventory management system that provides the retailer with inventory management and automated ordering of merchandise.

It is a further objective of the present invention to create a system to measure consumers shopping behavior across many retailers for strategic mining and analysis of shopping patterns.

It is still another objective of the present invention to allow consumers to request matching prices from a retailer while in-store based upon other sale prices that are broadcast to the consumer's wireless shopping device.

It is yet another objective of the present invention to allow consumers who are in-store to request an “on the spot” discount based upon volume of merchandise being purchased while in store.

It is a further objective of the present invention to create a wireless in-store “shopping cart” noting for the consumer all of the goods about to be purchased while in store.

It is still another objective of the present invention to allow a server to suggest a gift to be purchased based upon demographic information input by the consumer into a wireless shopping device.

It is yet another objective of the present invention to allow a consumer to create a personal/recipient profile while in-store or remote from the store, thereby allowing gift suggestions to be made over a wireless network.

It is still another objective of the present invention to allow a server to suggest matching products to go with product of interest based on purchase behavior of other shoppers or store recommendations.

It is yet another objective of the present invention to permit consumers to request that the retailer make an offer on goods to be purchased.

It is still another objective of the present invention to allow consumers the ability to check the status of a previously placed purchase order.

These and other objectives of the present invention will become apparent from a review of the specification that follows.

The present invention is a system and method for shopping wherein a consumer uses a wireless shopping device to identify and order goods from a merchant. The wireless shopping device comprises an ability to identify the goods to be ordered, transmit the order to a fulfillment center affiliated with or run by the merchant, and subsequently have the desired goods shipped to the consumer's residence or another location as desired.

A significant aspect of the present invention is the fact that the wireless shopping device of the present invention has a product identification means which, for example, could be a scanner for scanning UPC codes as well as communication means to allow the wireless shopping device to contact the fulfillment house to determine which of the desired goods are available. Once it is determined that the desired goods are in fact available, the consumer can purchase the goods using the wireless shopping device and by designating a payment methodology whether it be by prearranged credit or through a credit card.

In practice, the consumer would proceed to the retailer, see the particular merchandise desired to be purchased, use the wireless shopping device to scan an identification code associated with the goods to be purchased, connect to the fulfillment house to determine the availability and to purchase the goods, and receive an electronic confirmation of the purchase.

The advantage of the present invention is that consumers will be able to proceed to a particular retail establishment, see the goods to be purchased, purchase the goods, and leave the store without having to carry parcels that have been purchased.

The present invention also comprises a position locater, such as a global positioning system (GPS) device, so that, at any time, the user's location can be made known to a server having an electronic “yellow pages.” The consumer uses the wireless shopping device to designate the type of goods desired to be purchased. Thereafter, the server of the present invention identifies for the consumer, based upon the geographic location of the consumer, the nearest location of the desired goods. The consumer can designate an acceptable range, for example, a half-mile, or a mile from their given location. The server of the present invention then sends to the consumer's wireless shopping device, the location of stores that carry the desired goods, and any sales or discounts being offered on the goods desired.

Thus, using the present invention, a consumer can purchase desired goods without having to carry the goods home, and determine where the desired goods are actually located within a reasonable radius of the physical location of the consumer. In an additional embodiment, the consumer can purchase the desired goods with the wireless shopping device and receive a purchase code to present at checkout in order to take the goods from the store in an expedited fashion.

### BRIEF DESCRIPTION OF THE FIGURES

FIG. 1 illustrates the overall architecture of the present invention.

FIG. 2 illustrates the data flow processes of the proposed shopping services.

FIG. 3 illustrates the process of providing the consumer the unique purchase code to be used during checkout.

FIG. 4 illustrates the process of requesting and purchasing gift ideas.

FIG. 5A illustrates the process of creating wish lists and gift registries.

FIG. 5B illustrates the process of having a designated shopper.

FIG. 5C illustrates the process of creating and using private gift lists.

FIG. 6 illustrates the use of yellow pages to search for specific goods and the use of yellow pages services to locate stores identities and locations.

FIGS. 7A-D and 8A-D illustrate a preferred graphic interface of the present invention.

FIG. 9 illustrates another embodiment of the present invention.

### DETAILED DESCRIPTION OF THE INVENTION

As noted above, the present invention is a system and method for purchasing of goods and services in a wireless fashion while the consumer is in-store at a retailer's establishment or remotely through wireless interaction with the retailer.

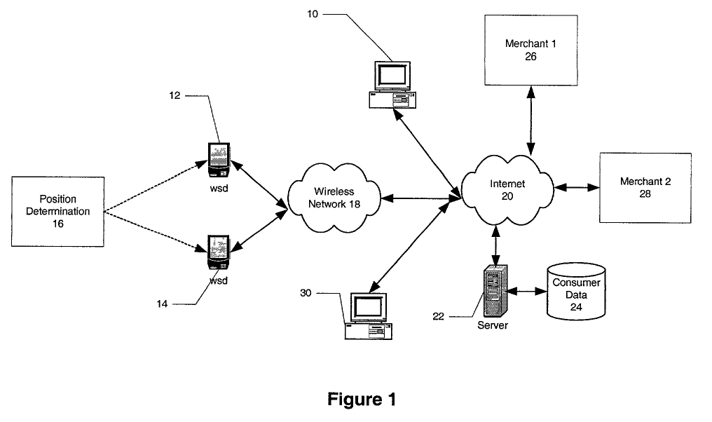

Referring first to FIG. 1, the overall architecture of the present invention is illustrated. The server 22 of the present invention system comprises a processor having memory, storage, communications capability and an array of programs and databases to support the objective of the present invention. For example, consumer files are maintained in the server storage 24 that relate to the identity of the consumer, contact information such as telephone numbers and internet addresses as well as contact information relating to the wireless shopping device(s) owned by the consumer and over which communications are to be sent. Further, the demographic information of the consumer along with preference for certain products or services are also maintained. In this way a consumer can be alerted to sales that a manufacturer is offering, and, as will be explained below, so that others with appropriate permission can access a list of items desired by the consumer. It should be noted that while a single server is illustrated, this is not meant as a limitation since multiple servers in communication with one another are also contemplated and are within the scope of the present invention. Additionally, where multiple servers are illustrated, this also is not meant as a limitation since it is also contemplated that a single server could provide multiple functions.

The server also allows files of “wish lists” and the associated stores at which the items on the list can be found. This list is stored in the server storage 28 and associated with the specific consumer. This capability allows consumers to see items in a store and designate those items as the type that the consumer desires. Thereafter, third parties can find out what the consumer needs as in, for example, a wedding present, Christmas present or for any other occasion.

The server 22 also maintains a database of those merchants that are subscribers to the system. Again contact information relating to the merchant is stored so that access can be accomplished over any appropriate network be it the Internet, a dial up network, a wireless network or over a PSTN. Further, a database of current sales, the geographic location of the stores of the merchant, and specific products offered by the merchant are also maintained.

The server also has a number of programs to support the consumer's shopping. A location analysis program receives information from a position determination means 16 and is processed by the server to allow the server to know where the consumer is physically located and how that location relates to the merchants that are subscribers to the system. This location program receives information for the position determination means 16 which may be the Global Positioning System (GPS), an RF triangulation program or other geographic location programs known in the art, via the wireless consumer device.

The location program compares that information regarding the location of the consumer and the location of subscriber stores, as well as the shopping needs and desires of the consumer, and notifies the consumer of the location of the nearest stores that sell the desired products. The location program in the server also receives the consumer's preferences for store locations (i.e. no more that one mile form the consumer location at any point in time) and factors those preferences into the location program.

The server further possesses notification programs that provide the consumer with a notification of sales of desired products. The server receives information on sales that are established by the merchant subscribers to the system. These sales events are stored, along with any limitations, and are compared to the consumer database. If the server determines that the consumer desires the goods that are on sale and that the particular consumer is on line, a notification is sent directly to the wireless shopping device of the consumer. If the consumer is not on line, the server stores the message as a shopping email to be retrieved by the consumer at a later time.

The database 24 is connected to the server 22. Server 22 is in turn connected to, preferably, the Internet 20 although this is not meant as a limitation. Other wired and wireless networks as noted above will also serve as well.

Subscriber merchants 26 and 28 are also connected to the network to which the server of the present invention is connected. These merchants register with the server of the present invention and provide store location, product and sale information to the server for dissemination to consumers.

The server 22 of the present invention can determine the location of the consumer by virtue of signals received from a position determination means 16 via the consumer's wireless shopping device. This position determination means is, as noted above, preferably the global positioning system (GPS) although this is not meant as a limitation. Any position determination means that allows the location of the consumer possessing the wireless shopping device for shopping is suitable for the present invention. Each consumer possesses a wireless shopping device 12,14. These wireless shopping devices have memory for storing programs relating to the sale and purchasing functionality noted herein and provide two-way data and voice communication with the server 22 of the present invention. Each wireless shopping device 12,14 has the capability of determining an identification code for the product to be purchased. The user of wireless shopping device 12, for example, proceeds to a particular retail establishment that is a subscriber merchant of the present invention. Once at the retail establishment, the consumer having wireless shopping device 12 can use the device to determine the price and availability of goods that are desired to be purchased.

The consumer uses the wireless shopping device 12 to scan a code or otherwise identify a particular product to be purchased. Once the user identifies the product, the user can cause the wireless shopping device 12 to send a signal over wireless network 18 over the Internet 20 to the server 22 of the present invention requesting a price for the item and availability of the item. The customer is also provided with reviews of the product by the server 22 so that the customer can make an informed buying decision.

The server 22 of the present invention reviews the information in its database 24 and, if price and availability information is available from the local database, conveys that information back over the Internet over 20, over the wireless network 18 to the wireless shopping device 12. If the server 22 of the present invention does not have appropriate price information in its own database, the server 22 sends a request for pricing and availability to merchants 26 and 28 as appropriate. If the product desired is at, for example, merchant 26, the server 22 will send an appropriate request for information to merchant 26. Thereafter, merchant 26 will provide the appropriate price information to the server 22 which conveys that information to wireless shopping device 12.

The merchant 26 also provides any sale information to the server 22 when such information becomes available and without the need for a specific request for such information. In this manner, a consumer using the wireless shopping device 12 can be notified of the latest sale information when the consumer is in the merchant's store. This notification is made in near real-time once the server 22 determines that a sale relating to merchant 26 is in progress, that the wireless shopping device 12 is on the air, that the wireless shopping device is at or near the store at which the sale is occurring, and if appropriate, the item is one that is desired by the consumer.

Consumers using the present invention can register with the server 22 through their individual wireless shopping devices 12,14 or through workstations or personal computers 10, 30 that are connected to the Internet. In this latter registration process, user/consumer workstations 10, 30 connect to Internet 20 and thereby access server 22. Individual profiles for the individual consumers can then be established along with the identity of the wireless shopping devices 12,14 (respectively) that are associated with the users who are using workstations 10 and 30.

The server of the present invention can also receive communication from wireless shopping devices 12,14 to help the consumer locate desired goods. In this instance, for example, a consumer having wireless shopping device 14 and, being in a particular location, inquires of server 22 the identity of the store that is geographically closest to the consumer and which carries the desired products to be purchased. The server 22 receives the location signal from wireless shopping device 14 over wireless network 18, over Internet 20 and then to the server 22. The server notes the location of the wireless shopping device 14, and also notes the product that is desired by the consumer having wireless shopping device 14. Armed with the location of the consumer, and information concerning the consumer's desire for new product, the server of the present invention 22 searches its own database 24 for the location of the merchant carrying a particular product who is within the pre-specified radius distance over which a consumer would be willing to travel to obtain the desired product. Once this is determined, a signal is sent back to the consumer over the Internet 20 and the wireless network 18 notifying the consumer of where the desired products may exists.

On line “Yellow Pages”

Another function of the present invention is to allow consumers who are in a particular geographic location to request of the server 22, the location of stores that have particular products that are desired by the consumer. Thus the consumer simply keys in or otherwise designates the products desired. By virtue of the server's location program, the server can inform the consumer of the store identity and location so that the consumer can proceed to the store with the desired merchandise.

The server will also have a record of any sales incentives at the stores near to where the consumer is located. Thus in addition to informing the consumer of store location, the server 22 can inform the consumer of where the best deals are for the products desired.

In-Store Purchasing

Using the present invention the consumer is also able to have a wide variety of in-store interactions with the merchant. For example, when a consumer is in the store, the consumer uses the wireless shopping device 12, 14 to identify and determine the price for goods desired. The consumer can then purchase the goods if they are in the store in a wireless mode without having to go through the conventional checkout process. The consumer simply identifies the goods desired, provides credit/debit card information (or any other form of electronic payment) over the wireless shopping device and receives an authorization code that denotes that the item to be purchased has been paid for.

The consumer then proceeds through a modified checkout procedure wherein the authorization code is made known to a checkout device. The code is verified and the consumer leaves with the desired goods.

In-Store Price Negotiation

Using the present invention, the consumer can perform in store negotiation and price comparison. Once the consumer locates the goods desired, price information concerning the goods is determined. The consumer may then inquire of the server 22 of the present invention if another merchant is offering the same goods on more favorable terms. If this is the case, the consumer can make those more favorable terms known to the merchant where the consumer is located via the wireless device.

All communication of the type noted above flow through the server 22, which facilitates contact with the subscribing merchants 26, 28. If the merchants agree to the price change, the consumer proceeds with the purchase procedure and an authorization code is issued. The consumer then checks out as noted above with the goods at a more favorable price.

Another form of in-store negotiation that takes place using the wireless shopping device 12, 14 is a bidding process. There may be many reasons why a merchant might be willing to accept lower prices that those marked for goods. The consumer using the wireless shopping device of the present invention again determines the price of the goods. The consumer can then notify the merchant via the wireless shopping device and the server 22 that the consumer desires to pay only a certain price for the goods desired. The merchant can then either accept the bid, reject the bid, or make a counteroffer for consideration. If an agreement is reached, the consumer purchases the desired goods in a wireless fashion as noted above, receiving an authorization code for checkout purposes.

Delivery Option Processing

It frequently may be the case that a consumer desires to purchase goods but does not desire to carry those goods from the store. This is the case where a consumer simply prefers goods to be delivered to his home or where the goods are to be delivered elsewhere. In either case, as part of the in-store purchasing of goods, the consumer is given the option of specifying where the goods are to be delivered. Using the wireless shopping device, the consumer can specify the consumer's own address or the address of another. The goods will then be delivered as desired.

Other Shopping Options

If the consumer so desires, other options for handling of goods can be designated using the wireless shopping device. For example, the consumer may want the goods to be held to later in the day when all shopping is completed or until a later date for pick up. Alternatively, the consumer can designate that the goods are to be gift wrapped for later pick up. These options are all performed via wireless transaction to the server 22, which in turn notifies the merchant of the consumer's choice.

Product Advice

As noted above the present invention allows a variety of product advice to be given to the consumer. Since the consumer will complete a consumer profile as part of the registration process, the server of the present invention can suggest items to be purchased by the consumer when the consumer is in the particular merchant's store. This suggestion is based on the user's demographic profile and stated desire for certain goods.

If a “wish list” or shopping list is generated by the customer, the server 22 of the present invention can remind the consumer of the items that are to be purchased. Further, the server can notify the consumer of any sales on desired items.

If the consumer is shopping for another person, the consumer can also signal to the server the demographic information on the person for whom a gift is to be purchased. The server can then suggest items based upon the demographics of the gift recipient and the items that are available in the store in which the consumer is located. The suggested gift can then be purchased in the wireless fashion noted above and shipping instructions can also be designated.

Buying Groups

A modem phenomenon in purchasing is the notion of buyers groups whereby many individuals band together to purchase a larger quantity of goods and thereby receive a greater discount on those goods. Using the wireless shopping device 12, 14 consumers can inquire of the server 22 while they are in-store if there are any buyers groups that are particularly useful in purchasing goods from the store in which the consumer is located. Any such groups are researched in the database 26, and the consumer is notified of their existence. The consumer can then join any such group on the spot, receive the appropriate codes or authorizations, and proceed with purchases in the store as a member of the buyers group in question. As noted earlier, the customer can also start a buying group and invite others to participate thereby also obtaining discounts on products.

Inventory Control

While there are significant advantages to the consumer in using the wireless shopping device of the present invention, there are significant advantages to retailers as well. By encouraging a “showroom” model for the purchase of goods and services retailers reap several benefits. Chief among them are inventory control. For large and small retailer alike the storage of inventory represents significant costs. Space must be allocated to inventory to meet consumer demands. Some guesswork is required in order to anticipate user purchase habits which can differ from region to region. Fulfillment of orders requires a staff of personnel at each location where inventory is located. Moving inventory from one location to another also requires efforts, expense and knowledge of where the inventory is actually located.

By having the showroom model, with inventory fulfilled from a central location, significant cost savings are reaped by the retailer. Inventory is stored mainly in one location leaving more room for a greater variety of goods to be displayed at the retail locations. Further, fulfillment from a central location means that fewer personnel are required across many retailers. Smaller retailers who might not ordinarily be able to have a separate fulfillment center can band together to have a central center that fills the needs of a number of retail establishments.

Inventory accounting and tracking also improves under the present invention. Since the inventory is all in one place, it is easier to track and account for. This in turn makes the spotting of buying trends easier with an accompanying accuracy in the ordering of further merchandise. Knowledge of the amount of merchandise on hand also makes the offering of incentives and sales easier since any given merchant can better understand the stock on hand. Decisions on how to move that stock can then be made in a more timely manner.

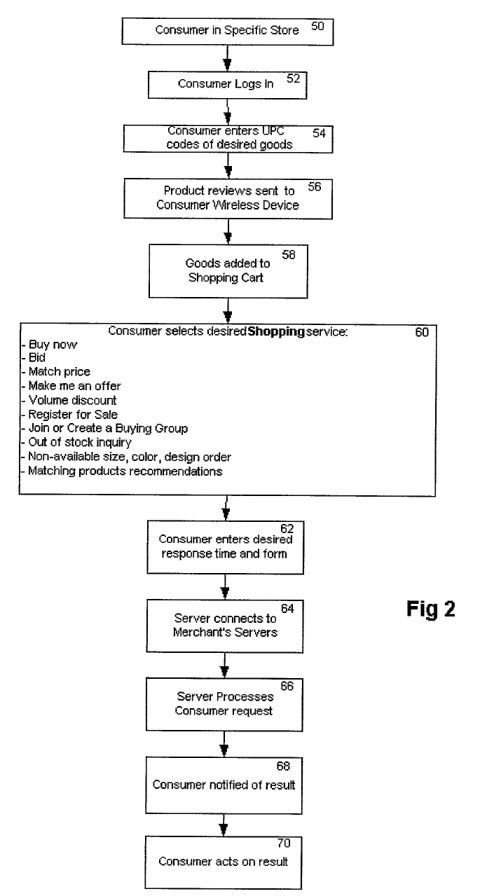

Referring to FIG. 2, an overview illustration of the shopping services of the present invention is illustrated. A consumer enters a specific store 50 and, using a wireless device that is either brought with a consumer or provided by the store, logs into the system of the present invention 52. Using, for example, a scanning capability on the wireless device, the consumer enters the UPC code of the desired goods 54. This UPC information is transmitted in a wireless fashion to the server of the present invention. In response to this UPC code and the implied desire to obtain information about the desired product, the server of the present invention downloads product reviews to the consumer's wireless device 56.

If after a review of the product reviews, the consumer desires to purchase the goods in question, the consumer so indicates and the goods are added to the electronic shopping cart 58 of the consumer.

The consumer then has a number of options available once the goods are added to the shopping cart. The consumer can purchase the goods immediately, bid on the goods at a price desired by the consumer, request that the store match the price of the goods offered in another location, and/or request that the store accept a specific offer other than the stated price from the consumer.

These various options allow the consumer to obtain the goods at a favorable price.

Additional functions also allow the consumer to have some flexibility in pricing. For example, the consumer can also request a volume discount when the number of shopping items in the shopping cart will exceed a certain dollar volume. The consumer can also register for any sale that is taking place, of which the consumer may not be aware.

Buying clubs are also a way of obtaining goods at a favorable price. The consumer can inquire and will receive information from the server relating to any existing buying group which the consumer may be eligible to join and which will result in the consumer obtaining goods at a more favorable price. Further, the consumer may form a buying group and invite others to join the buying group in order to obtain favorable pricing.

If an item is out of stock, the consumer can request of the server where the same goods may be obtained. If the goods can be obtained from a warehouse operation for the specific store in question, the server will so advise the consumer and an order may be placed. If a particular size, color or design is unavailable at the store in which the consumer is located, the consumer can place an inquiry to the server of the present invention to determine where the appropriate goods and services may be ordered. Additionally, and without limitation, the consumer may also inquire about other products which match the requirements for the desired product that the consumer would like to order. In this case, the server of the present invention will offer suggestions to the consumer for alternative goods that would be similar to those which the consumer desires to purchase, and which would be available on the specific store in which the consumer is located.

In response to all of these various shopping services, the consumer enters the desired response and completes an appropriate shopping request to order the desired goods 62. Thereafter, the server connects to the merchant's server 64 to place the order for the goods desired.

After the order is placed with the merchant's server, the consumer's request is processed 66, and the consumer is notified of the result 68. Such a result could be that the goods are available and can be shipped as desired by the consumer. The consumer then acts on the result by purchasing the goods and services electronically using credit instruments known in the art 70.

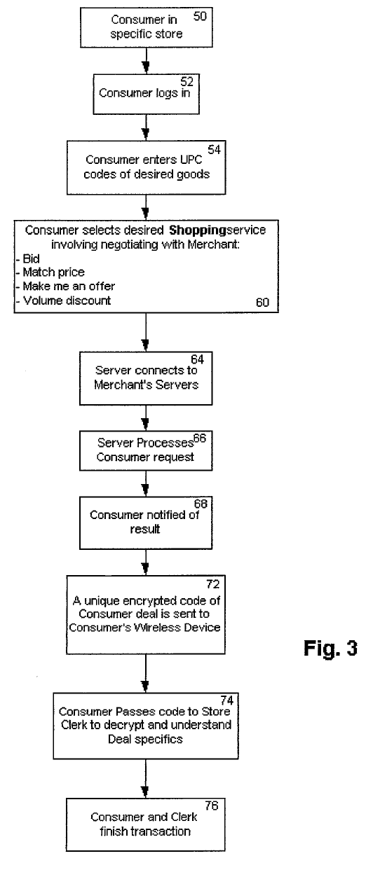

Referring to FIG. 3, the process flow whereby a store clerk is notified of the consumer's specific arrangement for the purchase of goods is illustrated. Again, the consumer enters a specific store 50 and logs onto the system of the present invention using the wireless device 52. The consumer finds and enters a UPC code or other graphical code or identifier associated with desired goods 54. The consumer then selects the shopping service desired which involves negotiating with the merchant 60. As noted above, such negotiations include bidding for the particular product, requesting a matching price, making an offer to the merchant, and/or obtaining a volume discount based upon total purchases.

The server receives the consumer's desired choice and connects to the merchant's server 64. The merchant server processes the consumer's request 66 and the consumer is notified of the results 68. Assuming that the merchant and the consumer have reached agreement on the specific method of purchase as noted above, a unique encrypted code relating to the consumer's specific deal for the goods being purchased is sent to the consumer's wireless device 72. In a specific checkout line for users of the present invention, the consumer passes the encrypted code to the store clerk who, using specific checkout equipment, decrypts and registers the specifics of the purchase for the goods by the consumer 74. The transaction is then completed with the consumer being charged in methods known in the art based upon the specific deal worked out between the consumer and the merchant at the time of purchase 76.

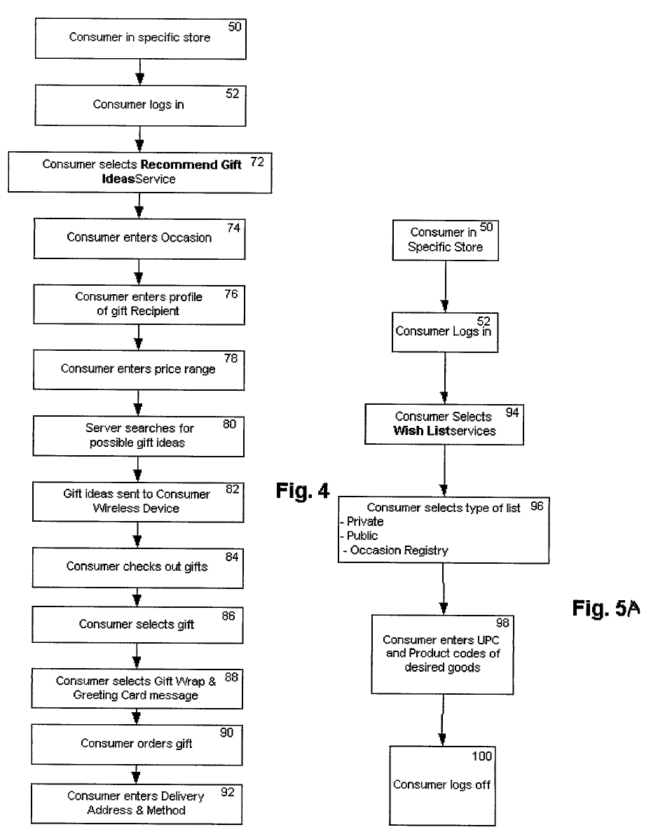

Referring to FIG. 4, the general flow for gift search services of the present invention is illustrated. The consumer enters a specific store 50 and logs onto the system of the present invention 52 using the wireless device of the consumer. Using an option screen presented to the user on the wireless device, the consumer selects the “recommended gift ideas” service 72. The user is prompted to and enters an occasion for which a gift is to be purchased 74. The consumer is then requested to enter the profile of a gift recipient 76 as well as the price range desired to be spent by the consumer 78.

Using an internal demographic database and listing of possible items to purchase that are located within the specific store in which the consumer is located, the server searches for possible gift ideas 80. The gift ideas are then transmitted to the consumer's wireless device 82.

After receiving ideas of gifts to be given, the consumer can explore those items within the store 84 and select the desired gift to be given 86. The selection is done electronically using the consumer's wireless shopping device. The consumer is then prompted to, and enters information relating to the type of gift wrap, greeting card message desired by the consumer 88. The consumer then finalizes the order for the gift 90, and is prompted to enter information relating to the delivery address and method 92.

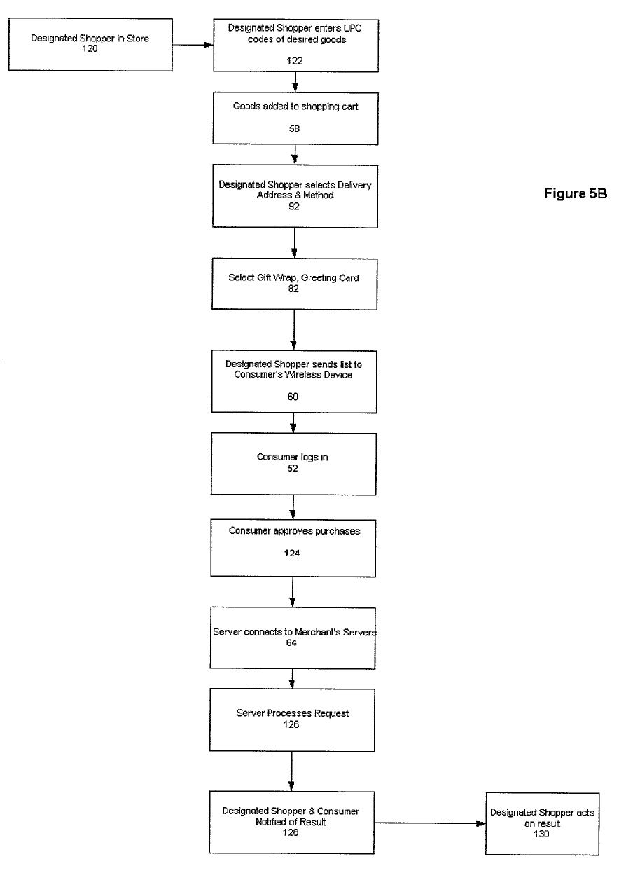

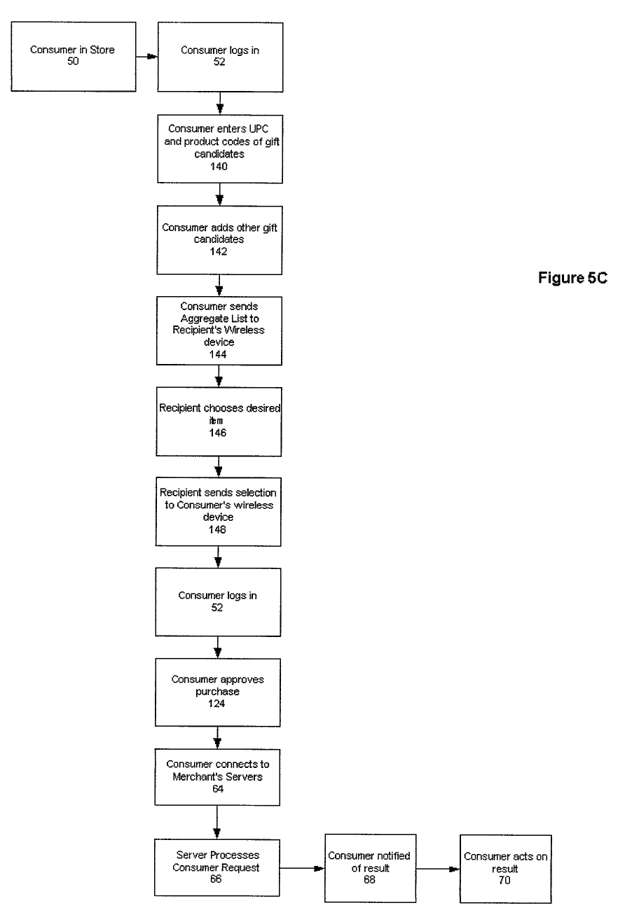

Referring to FIG. 5A, the process flow for creation of “wish lists” and “gift registries” is illustrated. A consumer again enters a specific store 50 and logs onto the system of the present invention using the wireless shopping device 52. The consumer then selects list creation services 94. The user is then prompted to enter the specific type of list that the user wants to create 96. For example, the list may be a private list to simply remind the consumer of types of things that the consumer would like to purchase. Alternatively, the list may be a public list so that regardless of the occasion, the list could be accessed by others who might wish to purchase certain goods for the consumer. Further, an occasion registry may be established whereby the consumer can establish a wedding, birthday, or other occasion registry where desired gifts can be registered as well as the fact that other individuals have purchased certain of the gifts on the list.

Once the specific type of list is created, the user enters the product identifier codes of the desired goods which are to be placed on the list 98. After establishing the initial list, the consumer logs off the system 100.

It should be noted that the list services can be augmented at any time that the consumer desires. By virtue of allowing specific access by a specific consumer, the list can be updated with additional gifts, certain gifts can be taken off the list, and the list can be changed as desired by the consumer.

Referring to FIG. 5B, the process of having a designated shopper shop for the consumer is illustrated. Often, the consumer cannot or does not want to shop himself. For instance, a boss may send his assistant to buy office gifts. The designated shopper process is useful for a parent to send a child shopping, yet retain control over what the child buys. The present invention allows the consumer to have a designated shopper choose all the desired items. Then, the consumer approves the list and pays for the items.

The designated shopper goes to a retail store 120. The designated shopper can choose various items and enter the UPC codes of all the items to be bought 122. Goods are entered into the consumer's electronic shopping cart 58. The designated shopper is prompted to enter any delivery address and shipping methods if the items are to be mailed 92. The designated shopper is further prompted to enter information relating to the type of gift wrap, greeting card message desired by the consumer 88.

Once the designated shopper compiles the full purchase list, he transmits the list from his wireless shopping device, over the wireless network to the consumer's wireless shopping device 60. The consumer logs in to the server 52 and reviews the shopping list the designated shopper has compiled. The consumer adds or deletes items, if desired, and approves the purchases 124. Once the purchase list is approved, the server connects to and notifies the merchants that the consumer authorized charges for the purchases 64. The merchant server processes the request 126. The server notifies both the consumer and the designated shopper on their wireless shopping devices of the purchase result 128. Then, the designated shopper may pick up the items, or perform whatever action is required 130. For instance, if a problem occurred in completing the transaction, the designated shopper attempts to solve the problem.

Referring to FIG. 5C, the process of creating and using private gift lists is illustrated. Buying a gift for another person can be very difficult when one is not sure whether the recipient will truly like the gift. The wireless shopping device of the present invention allows the consumer to create a list of potential gifts for a recipient, and let the recipient choose which item he or she would like.

The consumer enters a specific store 50 and logs onto the system of the present invention using the wireless device 52. The consumer selects products as “gift candidates” that he is willing to buy for the recipient. The consumer enters the UPC code of gift candidates into the wireless shopping device 140. The consumer further enters the UPC code of other gift candidates from other store locations 142. Such a situation would arise if the consumer is in a mall, for instance, and chose some items from department store A and some items from department store B. Once the consumer compiles the aggregate list, he sends it to the recipient's wireless shopping device 144. The recipient views the list and chooses the item he or she would like to have as a gift 146. The recipient's selection is transmitted back to the consumer's wireless shopping device 148.

Next, the consumer approves the purchase of the item the recipient selected from the gift candidate list 124. The server receives the consumer's desired choice and connects to the merchant's server 64. The merchant server processes the consumer's request 66 and the consumer is notified of the results 68. The consumer then acts on the result by purchasing the goods and services electronically using credit instruments known in the art 70.

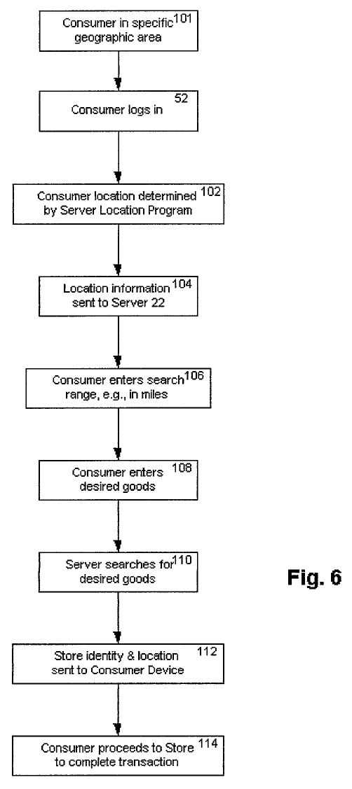

Referring to FIG. 6, use of the “yellow pages” services of the present invention to locate stores that sell desired goods is illustrated. A consumer who is located in a specific geographic area but not in a specific store 101 logs onto the system of the present invention using the wireless shopping device 52. The consumer's location is determined by the server location program 102. As noted above, such a program is fed information by RF location, triangulation, GPS information, or other location means known in the art.

Location information is sent to the server of the present invention 104. The consumer then enters a search range in miles or parts of miles 106. This search range indicates to the server the distance that the consumer is willing to travel from the consumer's present location in order to obtain certain desired goods. The consumer then enters the goods desired in general or specific categories 108. The server then searches its database of stores and goods located in stores to determine where the desired goods are located, within the mileage range specified by the consumer 110.

Once the goods are located in a specific store, the store identity and location is sent to the wireless shopping device 112. The consumer can then proceed to the store to complete the transaction as noted in earlier FIGS. 114.

Other Benefits

In addition to benefits to consumers and merchants, there are yet other “fallout” benefits of the present invention. In many regions, cellular and wireless use on weekends and evenings and other off-peak hours is minimal. It costs wireless operators much money to keep networks running even when demand is low. Since much shopping occurs on weekends, when wireless volume is typically lower than during business hours on a weekday (i.e. time of peak usage), the system of the present invention encourages wireless device use for a new purpose. Not only does this help retailing, but it also generates added revenue for wireless operators since higher bandwidth utilization now occurs on weekends as a result of use of the present invention.

Thus any entity running the present invention can generate revenue via merchant subscribers to the service offered. Wireless operators can make more money via their service and possibly provide a portion of that revenue to the entity operating the present invention.

A preferred embodiment of the present invention includes a user interface (UI) and presentation layer on the wireless device that is set on top of a search engine and supports performing and displaying results of searches within a merchant's database for products, prices, offered promotions and related information.

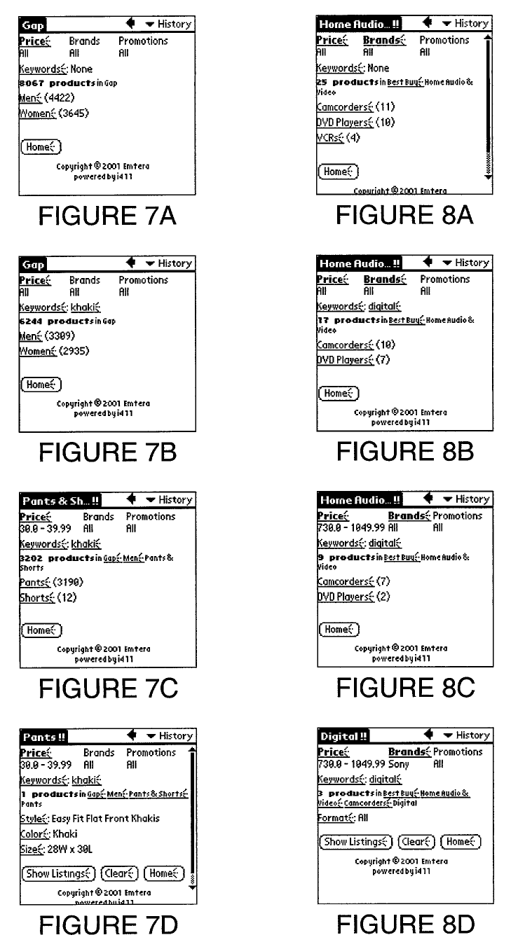

The UI preferably incorporates a 2-dimensional search and display style, as illustrated in FIGS. 7A-D and 8A-D, that is offered over any the wireless shopping devices, including PDAs and cell phones, but which can also be a 1-dimensional display for devices with limited screen size, such as cell phones. FIGS. 7A-D and 8A-D illustrate the UI on a PDA screen that supports a 2-dimensional display view.

As shown in the figures, a first dimension lays a list of product categories and the keyword search options. A second dimension lays three product attributes menus, such as but not limited to, price, brand and promotions. Under each of these menus are values for the corresponding attributes, such as but not limited to, price ranges, brand names and promotions currently offered by the merchant.

At the start, all products in the merchant's database are available to be searched and hence, include all product categories, all price ranges, all brand names and all promotions. FIG. 7A shows a display for the Gap® having 8067 products split into the product categories of “Men” and “Women” products. FIG. 8A likewise shows a display for the Best Buy® Home Audio & Video having 25 products split into the product categories of “Camcorders,” “DVD Players,” and “VCR” products.

To perform a search, the user starts with any attribute or search option, makes a selection and proceeds with other attributes and selections in no particular order. At any time the user makes a selection, that narrows down the products available to be searched based on that selection. In FIG. 7B, the search has been narrowed using the keyword “khaki” to thereby reduce the number of products to 6244 items. In FIG. 8B, the search has been narrowed using the keyword “digital.” Since there are no digital VCR's, the product categories are updated, in addition to the number of products being reduced to 17, to eliminate the “VCR” category.

FIG. 7C illustrates the further product refinement caused by selecting the “Men” category and the $30-$39.99 price range. In FIG. 8C, the further refinement is caused by selection of the $730-$1099.00 price range. This process continues until reaching the desired list of products and a “Show Listings” button is displayed, as illustrated in FIGS. 7D and 8D. In this presentation, the product categories displayed at any screen would depend on how far in the search process the subscriber has reached. Also, the sequence of selections made so far by the subscriber is shown at all times for reference, as well as a “Home” button to begin a new search.

As in the examples above, the user may start by entering a keyword. Now, all products in the database except those matching the keyword are eliminated and the product categories, prices, brand names, and promotions available to select from get reduced to those applicable to the remaining products. Next, the user may proceed by drilling down through the product categories and sub-categories. Similarly, after every selection, more products get eliminated and the product categories, prices, brand names, and promotions available to select from get reduced further to those applicable to the remaining products. At some point, s/he may select promotions and is presented with a list of promotions offered only on the remaining products. Upon selecting a specific promotion, that would further narrow down the search results to products available for that promotion. Similarly, the user may select price or brand, which would narrow the search results based on the selection. Alternatively, the user may start with promotions and select one of all the promotions offered by the merchant. Further searches would result in searching only within products available for that promotion.

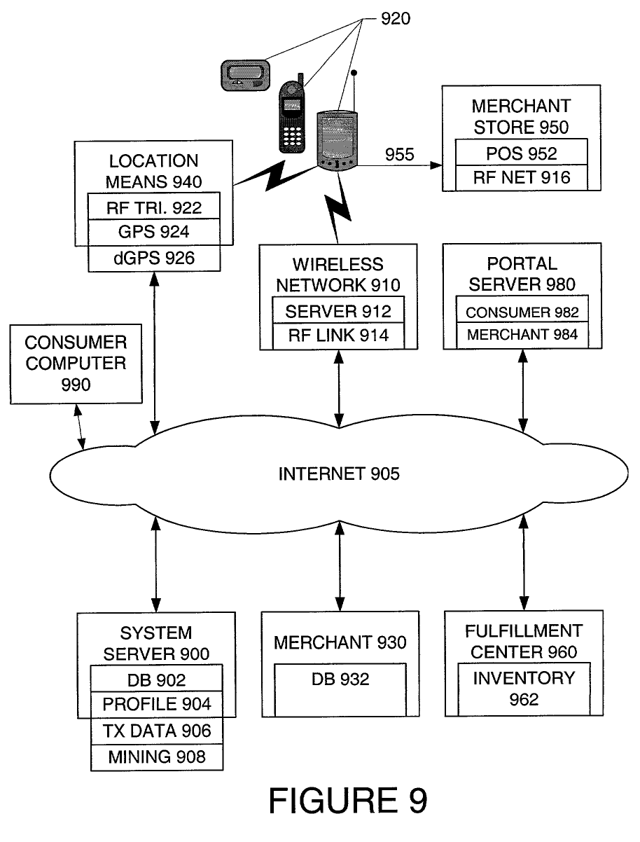

The present invention, as illustrated in FIG. 9, can be practiced in many different embodiments. At a basic level, the invention comprises system for wireless purchase of products and services, comprising a system server 900, a wireless communication means 910 connected to said system server 900 for communicating with a plurality of consumer wireless devices 920, at least one merchant database 932 for each merchant 930 connected to said system server 900 and comprising data related to products and services available for purchase from said merchant, a consumer database 902 connected to said system server 900 and comprising consumer profile 904 data, means 940 for determining a location of said consumer wireless devices, and means at said system server 900 for completing a purchase transaction for a product or service between a consumer and a merchant based on wireless communication between said system server 900 and a consumer wireless device 920.

In one embodiment, the consumer wireless devices 920 can be provided by a merchant to customers inside a merchant store 950 location. Such an arrangement could use a cellular telephone-type wireless network 910 that communicates with the system server 900 over the Internet 905 or could use a local wireless network 916 that uses shorter-range RF, such as IEEE 802.11, that communicates directly with a system server located in the store.

In a more typical embodiment, the consumer wireless devices 920 are selected from the group consisting of personal digital assistants (PDAs) and cell phones. The consumer wireless devices 920 include means for inputting product or service identifiers, such as scanners, keypads, touchscreens, cameras, and voice-recognition devices.

Typically, the wireless communication means 910 connected to said system server 900 will include a wireless server 912 having a radio frequency (RF) link 914 to said consumer wireless devices 920 and an Internet connection to said system server 900.

Typical means 940 for determining a location of said consumer wireless devices 920 include RF-triangulation means 922, GPS-based means 924, differential GPS-based means 926, and consumer-supplied input, such as by zip-code or cross-streets.

A fulfillment center 960 carrying inventory 962 can be connected to the system server 900, usually via the Internet 905 to provide for centralized inventory and a simpler supply chain. Consumers can order from anywhere, but will typically enter a merchant store 950 location for viewing products or receiving services. Store 950 locations include a point-of-sale (POS) terminal 952 for accepting an authorization 955 from a consumer wireless device 920 of a purchase transaction. As used herein, a POS terminal 952 can include a typical check-out register or a system designed specifically for an express checkout using the present invention, such as one that doesn't necessarily need a cash drawer, credit card reader, or cashier, but only a means for identifying the goods/services and a means for accepting the server-supplied authorization from the wireless device.

Registered Internet portal servers 980 can be connected to the system server 900 over the Internet 905 for exchanging portal consumer account information 982 or portal merchant information 984 with said system server.

Consumers can connect to the system server 900 over the Internet 905 using a consumer computer 990 or consumer wireless device 920 for creating consumer profiles, checking delivery status, creating shopping lists, etc. The system server 900 stores transaction data for various purposes. Consumers can access purchase histories for reordering products. Data mining means 908 associated with said system server 900 can analyze transaction data 906, as well as consumer profiles 904, to provide marketing data. The present invention allows the measurement of consumer shopping behavior across multiple merchants by including consumer profile data related to consumer desired products and consumer action on desired products. It also allows for adding desired products to said consumer profile, cross referencing the data with consumer account and demographic information, and generating reports predicting consumer shopping behavior based on collected and stored historical data about said consumer.

The basic process of the present invention comprises registering consumer profiles with the system server 900 and storing said consumer profiles on the database 902, registering merchants with the system server 900 and providing access to a merchant inventory database 932, wirelessly communicating with consumer wireless devices 920 to determine consumer location and identify products or services to be purchased, and completing the purchase transaction based on wireless communications between the system server 900 and said consumer wireless device 920. When the consumer wireless devices 920 are provided to consumers at a particular merchant store 950 location for use in said store, the consumer can register using the consumer wireless device 920 if they are not already registered.

Regardless of who supplies the consumer wireless devices 920, they can be used to identify products or services to be purchased by having the consumer input product identifiers into said consumer wireless device at a merchant store 950, usually after viewing and touching an actual example of the product.

In one embodiment, the consumer can take the product with them by having the system server 900 supply an authorization code 955 for the transaction to said consumer wireless device 920 and then supplying the authorization code 955 to a point-of sale (POS) terminal 952 to receive said products or services. In alternate embodiments, the consumer can elect to have the product gift wrapped and can elect diverse delivery options, such as having it held for later pickup at the merchant store 950 location, having it delivered to their home, having it delivered to an alternate location, such as a gift recipient's address, etc.

Merchants can directly register with the system server 900 or have an Internet portal associated with the merchant register the merchants and provide access to a merchant inventory database. Likewise, consumers have various registration options, such as by having an Internet portal having participating consumer account register the consumer's consumer profiles with the system server 900 and storing said consumer profiles on the database 902. Consumer registration can also be performed directly by the consumer via consumer computer 990 or consumer wireless device 920 connected to the system server 900 over the Internet 905. Registering can also be streamlined by selecting another Internet account from which to import stored account data and entering authentication data for said Internet account.

During a typical transaction, the system server 900 will determine availability and price of the product or service from the merchant database 932. A price can also be set by negotiating a price for the transaction by various methods, such as auction bidding, competitor-price matching, volume-purchase discounting, buying group discounting, preferred customer discounting, electronic-coupon discounting, (customer) offer- (merchant) acceptance, etc. Payment for the transaction can be selected from various methods, including, but not limited to, using a predetermined payment method stored in their consumer profile, using a payment account input by the consumer into said consumer wireless device, and using a selected Internet-based electronic wallet.

The system server 900 can assist the consumer in finding a desired item in many ways. When in a merchant store 950, the consumer can input a request for a location of certain product within the store and transmit said request to the system server 900, which accesses a merchant database to determine a department or aisle location where the product should be located and transmits the department or aisle location to the consumer wireless device 920.

The system server 900 can also suggest items to be purchased based on a variety of criteria, such as a wish list stored in the consumer profile, a shopping list stored in the consumer profile, a wish list linked to the consumer profile, a gift registry linked to the consumer profile, system server analysis of the consumer profile, system server analysis of the recipient profile data supplied by the consumer, system server analysis of a recipient's linked consumer profile, and by system server analysis of other items typically purchased with a previously selected item (e.g., if a bicycle is being purchased, the server can also suggest a helmet, lock, and water bottle).

The system server 900 can also aid the consumer by supplying reviews of products or services desired to be purchased, supplying sale information, supplying lists of popular items purchased by those with similar profiles, suggesting other similar products or services from the merchant, locating the same or other similar products or services from nearby registered merchants, locating the same product or service at a lower price from a registered merchant, locating other similar products most often purchased by registered consumers, and locating other similar products most highly rated by registered consumers or other rating sources.

The system server 900 can also aid the consumer by acting in a “yellow pages” capacity, wherein the consumer logs into the system server 900 via said wireless device 920, supplies data used to determine consumer location, selects products or services desired to be purchased, selects a desired geographic range, and the system server 900 searches merchant databases to determine possible merchants within the geographic range offering the selected products or services and transmits relevant data to said consumer wireless device 920 to assist in locating the products or services purchased. The search request can also include a desired merchant name. Additionally, relevant sale incentive data can be sent to the consumer.

Alternate methods of employing the present invention include having the consumer log into the system server 900 using an existing wireless service provider account or Internet portal account or having the consumer connecting to said system server, select a login using an existing wireless service provider account or Internet portal account, enter authentication data for the existing wireless service provider account or Internet portal account, and use a wallet from the existing wireless service provider account or Internet portal account to complete the purchase transaction.

In another embodiment, the system server 900 can detect a consumer wireless device 920 on a wireless network 910, determine the geographic location of the consumer wireless device 920, determine the availability of (i) merchant-specific offers, (ii) products or services matching products or services stored in said consumer profile, or (iii) product or service offers appropriate to demographic information and/or interests stored in said consumer profile 904, within an area adjacent the determined geographic location, and transmit the available merchant-specific offers to the consumer wireless device 920.

In another embodiment of the present invention, when the system server 900 determines that a product or service is not available from a merchant, the consumer can request the system server to determine if said product or service is available from an alternative source.

The present invention also allows the consumer to create a “buddy list” for storage in their consumer profile. The buddy list includes at least one buddy name, whether actual or a nickname, and an associated e-mail address or the like. Once a buddy has been added, the consumer can use the consumer wireless device 920 to direct the system server 900 to notify a selected buddy with information such as text messages (e.g., instant messages, SMS, etc.), details of selected buying groups, and details of other selected purchase opportunities such as sales, gifts ideas, etc.

In one embodiment of the present invention, the consumer completes the transaction using a single authorizing action, i.e., by a “1-click” method. This can be done by (i) having all necessary information stored in the consumer profile 904 on said system server 900 (an Amazon.com model), (ii) having all necessary information stored in the consumer wireless device 920 (a Vodaphone model) and transmitting it with said authorizing action, or (iii) having a first portion of the necessary information stored in the consumer profile 904 on the system server 900 and a remaining portion of the necessary information stored in the consumer wireless device 920 and transmitted with said authorizing action.

In another embodiment, the system server 900 stores transaction data 906 for each consumer as an order history. By providing consumers access to the transaction history, consumers can identify products or services for purchase by selecting the product or service from the order history, thereby facilitating repeat purchasing.

Another aspect of the present invention allows consumers to start buying groups using their wireless devices 920. The consumer requests initiation of a buying group for a product or service with said merchant using the consumer wireless device 920. The merchant can then accept said buying group by setting an initial price, setting a time period, agreeing to lower said price based on a volume of purchases through said buying group, and agreeing to sell the product or service at a conclusion of the time period to all members of the buying group at a final, lowered price.

As used herein, the term “merchant” applies to any entity supplying goods or services, including retailers and manufacturers. The term “consumer” applies to any entity purchasing goods or services, including individuals, groups, organizations and businesses. The term “Internet fulfillment center” applies to any remote inventory facility that ships goods, including facilities operated by manufacturers and facilities carrying the goods of multiple manufacturers.

A system and method for the wireless purchases of goods and service has now been illustrated. It will become apparent to those skilled in the art that the wireless shopping devices can take many forms from PDA's to cellular telephones with some added capabilities. The added capabilities may be inherent in the wireless devices or be add-on modules to those wireless devices.

We claim:

1. A system for wireless purchase of products and services, comprising:
a system server;
a wireless communication means connected to said system server for communicating with a plurality of consumer wireless devices;
at least one merchant database connected to said system server and comprising data related to products and services available for purchase from said merchant;
a consumer database connected to said system server and comprising consumer profile data;
means for determining a location of said consumer wireless devices; and
means at said system server for completing a purchase transaction for a product or service between a consumer and a merchant based on wireless communication between said system server and a consumer wireless device.

2. The system of claim 1, wherein said consumer wireless devices are provided by a merchant to customers inside a merchant store location.

3. The system of claim 1, wherein said consumer wireless devices are selected from the group consisting of personal digital assistants (PDAs) and cell phones.

4. The system of claim 1, wherein said consumer wireless devices include means for inputting product or service identifiers.

5. The system of claim 4, wherein means for inputting product or service identifiers is selected from the group consisting of scanners, keypads, touchscreens, cameras, and voice-recognition devices.

6. The system of claim 1, wherein said wireless communication means connected to said system server comprises a wireless server having a link to said consumer wireless devices selected from the group consisting of radio frequency (RF) links and infra red (IR) links.

7. The system of claim 6, wherein said wireless communication means connected to said system server further comprises an Internet connection to said system server.

8. The system of claim 1, wherein said means for determining a location of said consumer wireless devices is selected from the group consisting of RF-triangulation means, GPS-based means, differential GPS-based means, and consumer-supplied input.

9. The system of claim 1, further comprising a fulfillment center connected to said system server.

10. The system of claim 9, wherein said fulfillment center has an Internet connection to said system server.

11. The system of claim 1, further comprising a merchant store location for viewing products or receiving services.

12. The system of claim 11, further comprising a point-of-sale (POS) terminal for accepting an authorization from said consumer wireless device of said purchase transaction.

13. The system of claim 1, further comprising an Internet portal server, wherein said portal server is connected to said system server over the Internet and is registered with said system server for exchanging portal consumer account information with said system server.

14. The system of claim 1, further comprising a consumer computer or consumer wireless device connected to said system server and said system server including software instructions for creating consumer profiles based on communication with said consumer computer or consumer wireless device.

15. The system of claim 1, further comprising means associated with said system server for storing transaction data.

16. The system of claim 15, further comprising data mining means associated with said system server for analyzing transaction data and consumer profiles.

17. The system of claim 1, further comprising means to check delivery status associated with said means at said system server for completing a purchase transaction.

18. The system of claim 1, further comprising an Internet portal server, wherein said portal server is connected to said system server over the Internet and is registered with said system server for exchanging portal merchant information with said system server.

19. The system of claim 1, wherein said consumer wireless devices have built-in means for wireless communications.

20. A process for wireless purchasing of products and services, comprising:
registering consumer profiles with a system server and storing said consumer profiles on a database;
registering merchants with said system server and providing access to a merchant inventory database;
wirelessly communicating with consumer wireless devices to determine consumer location and identify products or services to be purchased; and
completing a purchase transaction for a product or service between a consumer and a merchant based on wireless communications between said system server and said consumer wireless device.

21. The process of claim 20, further comprising providing said consumer wireless devices to consumers at a particular merchant store location for use in said merchant store.

22. The process of claim 20, further comprising selecting said consumer wireless devices from the group consisting of PDAs and cell phones.

23. The process of claim 20, further comprising inputting product or service identifiers into said consumer wireless device.

24. The process of claim 23, wherein said inputting step is a step selected from the group consisting of scanning a code, operating a keypad, engaging a touchscreen, imaging with a camera, and speaking.

25. The process of claim 20, further comprising using a wireless server having a link to said consumer wireless devices to provide said wireless communicating selected from the group consisting of RF links and IR links.

26. The process of claim 25, further comprising connecting said wireless server to said system server over the Internet.

27. The process of claim 20, wherein said wireless communicating with consumer wireless devices is by radio frequency (RF) communication and wherein said wireless communicating with consumer wireless devices determines location by a method selected from the group consisting of RF-triangulation of said consumer wireless device, transmission of GPS coordinates from said consumer wireless device, and transmission of consumer supplied data.

28. The process of claim 20, further comprising delivering purchased products from a fulfillment center.

29. The process of claim 28, further comprising delivering fulfillment center instructions from said system server to said fulfillment center over the Internet.

30. The process of claim 20, wherein the step of wirelessly communicating with consumer wireless devices to identify products or services to be purchased comprises said consumer inputting product identifiers into said consumer wireless device at a merchant store.

31. The process of claim 30, wherein the step of completing a purchase transaction further comprises:
supplying an authorization code for said transaction from said system server to said consumer wireless device; and
supplying said authorization code to a point-of sale (POS) terminal to receive said products or services.

32. The process of claim 20, further comprising registering an Internet portal having participating merchants as a means of registering merchants with said system server and providing access to a merchant inventory database.

33. The process of claim 20, further comprising registering an Internet portal having participating consumer account as a means of registering consumer profiles with said system server and storing said consumer profiles on a database.

34. The process of claim 20, wherein said step of registering consumer profiles with a system server is performed by a consumer via a personal computer or consumer wireless device connected to said system server over the Internet.

35. The process of claim 20, further comprising storing of said transaction data by said system server.

36. The process of claim 35, further comprising mining data by analyzing said transaction data and said consumer profiles.

37. The process of claim 20, wherein the step of wirelessly communicating with consumer wireless devices to determine consumer location and identify products or services to be purchased comprises the steps of:
a consumer entering a merchant location;
said consumer logging into said system server via said consumer wireless device and supplying data used to determine consumer location;
said consumer selecting products or services desired to be purchased from said merchant; and
said consumer inputting a product or service identifier into said consumer wireless device and wirelessly transmitting said identifier to said system server.

38. The process of claim 37, wherein said data used to determine consumer location is selected from consumer-supplied information, consumer wireless device-supplied GPS information, and RF transmissions received for triangulation.

39. The process of claim 37, wherein the step of completing a purchase transaction between a consumer and a merchant further comprises:
said system server determining availability and price of said product or service from said merchant database.

40. The process of claim 37, wherein the step of wirelessly communicating with consumer wireless devices to identify products or services to be purchased further comprises:
said consumer inputting a request for a location of certain product within said store and transmitting said request to said system server via said consumer wireless device;
said system server accessing said merchant database to determine a department or aisle location where said product should be located and transmitting said department or aisle location to said consumer wireless device.

41. The process of claim 39, wherein the step of completing a purchase transaction further comprises negotiating a price for the transaction by a method selected from the group consisting of auction bidding, competitor-price matching, volume-purchase discounting, buying group discounting, preferred customer discounting, electronic-coupon discounting, and offer-acceptance.

42. The process of claim 37, wherein the step of completing a purchase transaction further comprises providing payment by a method selected from using a predetermined payment method stored in said consumer profile, using a payment account input by said consumer into said consumer wireless device, and using a selected Internet-based electronic wallet.

43. The process of claim 37, wherein the step of completing a purchase transaction further comprises selecting a delivery method from a group consisting of Internet fulfillment to a predetermined address stored in said consumer profile, Internet fulfillment to an address input into said consumer wireless device, immediate store fulfillment, and deferred store fulfillment.

44. The process of claim 43, wherein said Internet fulfillment or store fulfillment further comprises gift-wrapping.

45. The process of claim 37, wherein the step of wirelessly communicating with consumer wireless devices to identify products or services to be purchased further comprises said system server suggesting items to be purchased based on a means selected from a group consisting of a wish list stored in said consumer profile, a shopping list stored in said consumer profile, a wish list linked to said consumer profile, a gift registry linked to said consumer profile, system server analysis of said consumer profile, system server analysis of recipient profile data supplied by said consumer, system server analysis of a recipient's linked consumer profile, and system server analysis of other items typically purchased with a previously selected item.

46. The process of claim 37, wherein the step of wirelessly communicating with consumer wireless devices to identify products or services to be purchased further comprises:
said consumer requesting a review of products or services desired to be purchased from said system server; and
said system server delivering a review of said products or services to said consumer wireless device.

47. The process of claim 37, wherein the step of wirelessly communicating with consumer wireless devices to identify products or services to be purchased further comprises said system server determining and transmitting to said consumer wireless device alternate products or services selected from the group consisting of other similar products or services from said merchant, the same or other similar products or services from nearby registered merchants, the same product or service at a lower price from a registered merchant, other similar products most often purchased by registered consumers, and other similar products most highly rated by registered consumers or other rating sources.

48. The process of claim 20, wherein the step of completing a purchase transaction further comprises providing payment by a method selected from using a predetermined payment method stored in said consumer profile, using a payment account input by said consumer into said consumer wireless device, and using a selected Internet-based electronic wallet.

49. The process of claim 20, wherein the step of completing a purchase transaction further comprises selecting whether or not to have the purchase gift wrapped and selecting a delivery method from a group consisting of Internet fulfillment to a predetermined address stored in said consumer profile, Internet fulfillment to an address input into said consumer wireless device, immediate store fulfillment, and deferred store fulfillment.

50. The process of claim 20, wherein the step of wirelessly communicating with consumer wireless devices to identify products or services to be purchased further comprises said system server suggesting items to be purchased based on a means selected from a group consisting of a wish list stored in said consumer profile, a shopping list stored in said consumer profile, a wish list linked to consumer profile, a gift registry linked to said consumer profile, system server analysis of said consumer profile, system server analysis of recipient profile data supplied by said consumer, system server analysis of a recipient's linked consumer profile, and system server analysis of other items typically purchased with a previously selected item.

51. The process of claim 20, wherein the step of wirelessly communicating with consumer wireless devices to determine consumer location and identify products or services to be purchased further comprises:
said consumer logging into said system server via said consumer wireless device and supplying data used to determine consumer location;
said consumer selecting products or services desired to be purchased;
said consumer selecting a desired geographic range; and
said system server searching merchant databases to determine possible merchants within the geographic range offering the selected products or services and transmitting relevant data to said consumer wireless device to assist in locating said products or services purchased.

52. The method of claim 51, further comprising said system server transmitting relevant sale incentive data to said consumer wireless device.

53. The process of claim 51, wherein said data used to determine consumer location is selected from consumer-supplied information, consumer wireless device-supplied GPS information, and RF transmissions received for triangulation.

54. The process of claim 51, wherein the step of completing a purchase transaction between a consumer and a merchant further comprises:
said system server determining availability and price of said product or service from said merchant database.

55. The process of claim 51, wherein the step of wirelessly communicating with consumer wireless devices to identify products or services to be purchased further comprises:
said consumer entering a merchant store location;
said consumer inputting a request for a location of a certain product within said store and transmitting said request to said system server;
said system server accessing said merchant database to determine a department or aisle location where said product should be located and transmitting said department or aisle location to said consumer wireless device.

56. The process of claim 54, wherein the step of completing a purchase transaction further comprises negotiating a price for the transaction by a method selected from the group consisting of auction bidding, competitor-price matching, volume-purchase discounting, buying group discounting, preferred customer discounting, electronic-coupon discounting, and offer-acceptance.

57. The process of claim 51, wherein the step of completing a purchase transaction further comprises providing payment by a method selected from using a predetermined payment method stored in said consumer profile, using a payment account input by said consumer into said consumer wireless device, and using a selected Internet-based electronic wallet.

58. The process of claim 51, wherein the step of completing a purchase transaction further comprises selecting a delivery method from a group consisting of Internet fulfillment to a predetermined address stored in said consumer profile, Internet fulfillment to an address input into said consumer wireless device, immediate store fulfillment, and deferred store fulfillment.

59. The process of claim 58, wherein said Internet fulfillment or store fulfillment further comprises gift-wrapping.

60. The process of claim 51, wherein the step of wirelessly communicating with consumer wireless devices to identify products or services to be purchased further comprises:
said consumer requesting a review of products or services desired to be purchased from said system server via said consumer wireless device; and
said system server delivering a review of said products or services to said consumer wireless device.

61. The process of claim 51, wherein the step of wirelessly communicating with consumer wireless devices to identify products or services to be purchased further comprises said system server determining and transmitting to said consumer wireless device alternate products or services selected from the group consisting of the same product or service at a lower price from a registered merchant, other similar products most often purchased by registered consumers, and other similar products most highly rated by registered consumers or other rating sources.

62. The method of claim 20, wherein said step of wirelessly communicating with consumer wireless devices to determine consumer location and identify products or services to be purchased further comprises:
locating a merchant store by:
said consumer inputting data to define a geographic search area and transmitting a search request including said geographic search data to said system server; and
said system server identifying and transmitting data relevant to said search request to said consumer wireless device.

63. The method of claim 62, wherein said search request further comprises a desired merchant name.

64. The method of claim 20, wherein said step of registering consumer profiles with a system server and storing said consumer profiles on a database comprises a consumer:
connecting to said system server over the Internet;
establishing an individual consumer profile; and
linking said profile to a wireless consumer device.

65. The method of claim 64, wherein said step of registering is streamlined by selecting another Internet account from which to import stored account data; and entering authentication data for said Internet account.

66. The method of claim 20, wherein said step of wirelessly communicating with consumer wireless device is accomplished by said consumer logging into said system server using an existing wireless service provider account or Internet portal account.

67. The method of claim 20, wherein said step of wirelessly communicating with consumer wireless device is accomplished by:
said consumer connecting to said system server;
selecting a login using an existing wireless service provider account or Internet portal account;
entering authentication data for said existing wireless service provider account or Internet portal account; and
using a wallet from said existing wireless service provider account or Internet portal account to complete said purchase transaction.

68. The method of claim 20, wherein said step of wirelessly communicating with consumer wireless device is accomplished by:
said system server detecting a consumer wireless device on a wireless network;
said system server determining a geographic location of said consumer wireless device;
said system server determining the availability of merchant-specific offers within an area adjacent said determined geographic location; and
said system server transmitting said available merchant-specific offers to said consumer wireless device.

69. The method of claim 20, wherein said step of wirelessly communicating with consumer wireless device is accomplished by:
said system server detecting a consumer wireless device on a wireless network;
said system server determining a geographic location of said consumer wireless device;
said system server determining the availability of products or services matching products or services stored in said consumer profile within an area adjacent said determined geographic location; and
said system server transmitting said available matching products or services data to said consumer wireless device.

70. The method of claim 20, wherein said step of wirelessly communicating with consumer wireless device is accomplished by:
said system server detecting a consumer wireless device on a wireless network;
said system server determining a geographic location of said consumer wireless device;
said system server determining the availability of product or service offers appropriate to demographic information and/or interests stored in said consumer profile within an area adjacent said determined geographic location; and
said system server transmitting said available matching products or services offers to said consumer wireless device.

71. The method of claim 20, further comprising:
allowing consumers to create a list of products and services;
storing said list on said system server; and
allowing said consumer to make said list either publicly or privately available.

72. The method of claim 71, wherein said list is selected from the group consisting of a shopping list, a wish list, and a gift registry.

73. The method of claim 20, further comprising said consumer checking delivery status using said consumer wireless device.

74. The method of claim 20, further comprising loading desired products or services into an electronic shopping cart prior to said purchase transaction.

75. The method of claim 74, wherein a person in possession of said consumer wireless device is a designated shopper of said consumer and further comprising a step of providing said consumer access to said electronic shopping cart for adjustment and approval of said transaction.

76. The method of claim 20, further comprising:
said consumer creating a buddy list for storage in said consumer profile, said buddy list including at least one buddy name and an associated e-mail address; and
said consumer directing said system server to notify a selected buddy with information selected from the group consisting of text messages, details of selected buying groups, and details of other selected purchase opportunities.

77. The method of claim 20, further comprising said consumer completing said transaction using a single authorizing action, wherein all necessary information to complete said transaction is provided by a method selected from the group consisting of having all necessary information stored in said consumer profile on said system server, having all necessary information stored in said consumer wireless device and transmitted with said authorizing action, and having a first portion of all necessary information stored in said consumer profile on said system server with a remaining portion of all necessary information stored in said consumer wireless device and transmitted with said authorizing action.

78. The method of claim 20, further comprising:
said system server storing said transaction data for each consumer as an order history;
providing consumers access to said transaction history; and
allowing consumers to identify products or services for purchase by selecting said product or service from said order history.

79. The method of claim 20, wherein said wirelessly communicating with consumer wireless devices to identify products or services to be purchased and completing a purchase transaction for a product or service comprises:
said consumer requesting initiation of a buying group for a product or service with said merchant via said consumer wireless device; and
said merchant accepting said buying group by setting an initial price, setting a time period, agreeing to lower said price based on a volume of purchases through said buying group, and agreeing to sell said product or service at a conclusion of said time period to all members of said buying group at a final, lowered price.

80. The method of claim 39, wherein when said server determines that said product or service is not available from said merchant, said consumer requests said server to determine if said product or service is available from an alternative source.

81. The method of claim 80, wherein said availability is in-store availability and said alternate source is selected from the group consisting of other stores of said merchant, Internet fulfillment though said merchant, stores of other merchants, and Internet fulfillment through other merchants.

82. The method of claim 54, wherein when said server determines that said product or service is not available from said merchant, said consumer requests said server to determine if said product or service is available from an alternative source.

83. The method of claim 82, wherein said availability is in-store availability and said alternate source is selected from the group consisting of other stores of said merchant, Internet fulfillment though said merchant, stores of other merchants, and Internet fulfillment through other merchants.

84. The method of claim 74, wherein said consumer fills said shopping cart with gift items for a recipient and further comprising a step of providing said recipient access to said electronic shopping cart for adjustment prior to said consumer approving said transaction.

85. The method of claim 84, wherein said shopping cart is filled with products or services from multiple merchants.

86. The method of claim 75, wherein said shopping cart is filled with products or services from multiple merchants.

87. The method of claim 71, wherein said list is populated with products or services from multiple merchants.

88. The system of claim 16, wherein said data mining means measures consumer shopping behavior across multiple merchants by including consumer profile data related to:
consumer desired products; and
consumer actions on desired products;
and further comprising means for adding desired products to said consumer profile, cross referencing with consumer account and demographic information, and generating reports predicting consumer shopping behavior based on collected and stored historical data about said consumer.

89. The method of claim 36, further comprising measuring consumer shopping behavior across multiple merchants by including consumer profile data related to:
consumer desired products; and
consumer actions on desired products;
and further comprising adding desired products to said consumer profile, cross referencing with consumer account and demographic information, and generating reports predicting consumer shopping behavior based on collected and stored historical data about said consumer.
